(19) United States
(12) Patent Application Publication
(10) Pub. No.: US 2004/0236838 A1
(43) Pub. Date: Nov. 25, 2004

(54) Method and code for authenticating electronic messages

(75) Inventor: Walid R. Tout, Ypsilanti, MI (US)

Correspondence Address: BRINKS HOFER GILSON & LIONE, P.O. BOX 10395, CHICAGO, IL, 60610, US

(73) Assignee: Safe E Messaging, LLC

(21) Appl. No.: 10/794,959

(22) Filed: Mar. 5, 2004

Related U.S. Application Data
(60) Provisional application No. 60/320,220, filed on May 24, 2003.

(51) Int. Cl. G06F 15/16; H04L 9/32; G06F 11/30; G06F 12/14

(52) U.S. Cl. 709/207; 713/200

(57) ABSTRACT

In a method for authenticating an electronic message to thereby blocking unsolicited messages (“SPAM”), a first server generates a unique message identifier and an associated validation record upon authenticating a sender as one from whom a given recipient has agreed to receive electronic messages. The message identifier is included in the message, as sent to the recipient. The recipient retrieves the message identifier from the message and thereafter requests validation of the message identifier from either the first server, or a second server receiving the validation record and at least a recipient identifier associated with the recipient from the first server. After authenticating the recipient, the first or second server validates the message identifier by checking for the existence of the validation record, and returns an indication of message validation. The message is then accepted or rejected and, perhaps, routed to a folder for subsequent processing, based on the indication.

### CROSS-REFERENCE TO RELATED APPLICATIONS

This application claims benefit of U.S. provisional patent application No. 60/320,220, filed May 24, 2003, entitled “Safe E-Messaging,” the disclosure of which is hereby incorporated herein by reference.

### BACKGROUND OF THE INVENTION

1. Field of the Invention

The invention relates to methods and associated computer-executable instructions (“code”) for authenticating electronic messages, including e-mail messages, Instant Messaging, messages delivered to PDA's and portable devices, and SMS messages.

2. Background Art

Electronic messaging is one of the most successful markets in existence today. Tens of billions of electronic messages, ranging from e-mail messages, Instant Messages, and PDA messages to mobile SMS messages, are exchanged every day. Tens of thousands of businesses and hundreds of millions of people around the world rely on the ability to send and receive these messages on daily basis. Yet, the proliferation of unsolicited messages or SPAM is currently threatening to disrupt and seriously damage these communications. While most of the recent attention has focused on spamming as it relates to e-mail, spammers have also been turning more and more attention to other venues such as Instant Messaging (SPIM) and SMS. SPAM has been on the rise in recent years and shows no signs of halting or even slowing, despite major efforts to thwart its growth. On the contrary, e-mail SPAM is estimated to grow to roughly seventy-five percent of all e-mail traffic by 2007.

A number of strategies exist to deal with SPAM. These include Content-Based Filtering, White and Black Lists, Domain-based, Internet Protocol (“IP”) and Network-based filtering, passworded messages, and local and global lists with individual or group member contributions. Content-based filtering relies mainly on scanning a message and searching for certain keywords and/or patterns within the message. The classification of messages as SPAM is based on the results of these scans and whether certain keywords or patterns were located. Proponents of such methods claim very high percentages, in the ninety-percent range of success. However, these methods suffer a major drawback in the form of misclassification of messages. Even with success rates in the ninety-percent range, they still produce both False Positives, i.e., valid messages misclassified as SPAM, and False Negatives, i.e., SPAM messages misclassified as valid messages. The bigger problem of these two misclassifications is the False Positives, as this eventually leads to either missing important legitimate messages or the need for the user to go through the banned or quarantined message list in order to ensure they are not losing important messages, hence invalidating the overall advantage of deploying SPAM filtering software.

White and Black Lists are lists of acceptable and unacceptable e-mail senders, respectively. These lists can be constructed by individual users, user groups, or sellers of Anti-SPAM services. Incoming messages are scanned for their originating addresses and are allowed or stopped based on inclusion or exclusion from the corresponding lists. The main notion behind such schemes is that the origin of a given e-mail message can be identified through the message header, a notion that is factually wrong and is currently being challenged by an increasing number of spammers whose messages carry “faked” originating e-mail addresses. The fact is that the current e-mail infrastructure cannot guarantee the identity of the “Sender.” This identity theft can also lead to a double SPAM run, where a SPAM is sent with a fake Sender address. A number of angry recipients send messages back to the “Sender” complaining about the SPAM, and the unlucky legitimate holder of that e-mail address ends up with potentially thousands of mainly angry e-mail messages in their box.

Another method that is used is the filtering based on IP, domain names or subnets where the e-mail message originated. Both inclusion as well as exclusion lists are employed to either accept or reject messages based on originating domain or IP numbers. These lists are constructed by monitoring content or patterns of messages being sent from certain addresses and networks and classifying them accordingly. The effectiveness of these measures is questionable given the fact that spammers are quite mobile and can easily move from one place or address to another. In addition, spammers already have the ability to mask their true location by routing their messages through national as well as international proxy servers and open e-mail relays. Another problem with such schemes is the potential for service interruption because of erroneous or over-aggressive classifications. In some extreme cases, abuses by spammers of services from a number of ISPs caused these ISPs and their respective clients to be completely banned from sending e-mail messages to all users of AOL.

Other methods for SPAM control make use of passwords where the recipient provides desirable senders with a password to be included in their message. Messages are filtered based on the availability of such password within the message. Subsequently, the sender of these messages is added to some sort of a White List to be allowed to send future messages. These and similar approaches suffer from the same problems discussed earlier with White and Black Lists approaches. In addition, e-mail is mostly sent in clear text between sender and recipient, and passwords may be collected and harvested from intercepted messages.

Other methods to combat SPAM include legislation and legal measures. The first half of 2003 witnessed a great momentum to pass legislation with the intention of stopping SPAM or, at the very least, slowing it down. Many observers and experts, however, are of the opinion that while legislation can be of great help, it is not the solution to the problem. There is a strong perception that spammers are not overly concerned with the law and will continue with their operations. Another reason is that, because the Internet itself is a global resource, SPAM is in fact more of an international issue. The effects of any laws tend to be more localized to the geography where they are enacted. It is thus highly likely that spammers will find ways around the law and can also move their operations off-shore where the enacted laws will not reach them.

In addition to e-mail, the problem of SPAM is extending itself to the areas of Instant Messaging and Mobile Communication. Users of mobile devices, including PDA's and cell phones with Internet connectivity or SMS, are starting to feel the effects of SPAM and, in this case, the effects are more than just annoyances. For mobile users, SPAM translates into direct economical costs as users are usually charged per bytes transferred back and forth between their devices and the corresponding networks.

Instant messaging is poised to penetrate the corporate world and become one of its nerve centers and a primary medium for communication, collaboration, and information sharing and dissemination. As such, SPAM control and message authentication become extremely pressing problems; If not handled properly at this early stage of adoption, they can threaten the success of the medium itself before it gets completely off the ground and become a success in this market segment.

A further issue raised by current messaging systems is the ability of worms, viruses and other kinds of undesirable message payloads to transmit themselves to virtually millions of users in a very rapid manner. Because such payloads generate SPAM using the recipient's own computer, the prior art approaches identified above are generally unable to discriminate such SPAM from legitimate messages and, hence, are ineffective in stopping the proliferation of such payloads via electronic messaging.

### BRIEF SUMMARY OF THE INVENTION

It is an object of the invention to provide a method for authenticating electronic messages to thereby reduce or eliminate receipt of unsolicited messages or “SPAM,” including any retransmission of unwanted message “payloads.”

It is another object of the invention to provide a method for authenticating electronic messages, wherein messages are accepted or rejected based on a validation that takes into account an authentication of the sender as one from whom the recipient has agreed to receive messages.

It is a further object of the invention to authenticate electronic messages based on a validation record that is associated with both a unique message identifier, generated prior to transmission of the message and included in the message as sent to a recipient, and a recipient identifier.

It is yet another object of the invention to authenticate electronic messages using a unique message identifier and associated validation record, wherein the message identifier and validation record are generated by a server only when the message is sent to a recipient by a sender from whom the recipient has agreed to receive messages.

According to the invention, a method for authenticating an electronic message from a sender to a recipient who has indicated a willingness to receive messages from the sender includes generating a unique message identifier for transmission in the message, and a validation record associated with the message identifier and a recipient identifier associated with the recipient. The method further includes validating the message identifier forwarded by the recipient with the validation record.

In accordance with an aspect of the invention, the method preferably further includes authenticating the identity of the sender prior to generating the message identifier. In an exemplary method for practicing the method, the sender is authenticated by associating a sender identifier, provided by the sender in the request for the message identifier, with a list of sender list provided or maintained by the recipient. The sender identifier may either be on the sender list, or the sender list may include a group identifier with which the sender identifier is associated, either directly or through use of sub-group identifiers. As a further alternative, the sender list may include a default sender identifier, with which the sender may be authenticated, for example, by supplying information originating with the recipient, such as the recipient identifier coupled with a special password to be used for this purpose.

In accordance with another aspect of the invention, to further ensure that the message, as well as the sender, is authentic, in a preferred method for practicing the invention, the message identifier is generated based at least in part on a message fingerprint.

In accordance with another aspect of the invention, in a preferred method for practicing the invention, validating the message includes confirming the existence of the validation record, and flagging the validation record after confirming its existence to thereby ensure that the validation record can only serve to validate the unique message identifier one time. Where the message is to be sent to multiple recipients, a validation record, associated with both a given message identifier, is created for each recipient whose respective sender list includes a sender identifier associated with the sender. Thus, a message is deemed valid if the validation record corresponding to its message identifier and the recipient identifier is found. Otherwise, the message is deemed invalid because no corresponding sender-created validation record was found. Reasons for the missing validation record may include, among other things, the message being forged by somebody other than the sender, or the recipient has not identified the sender as one from whom he chooses to receive messages. If the message is validated, the message will be delivered to the recipient; otherwise, the message is either deleted or sent to a corresponding storage area (e.g., “Junk Folder” in an e-mail context) for later operations or processing.

The invention thus advantageously provides that an electronic message is authenticated by verifying and validating that a message originated from a authenticated sender and is “delivered,” upon suitable processing of an indication of message validity returned by a validation server, only if the recipient has already agreed to receive messages from the sender.

In accordance with an aspect of the invention, the invention can be implemented through either a centralized or distributed network topography. By way of example only, the invention can be implemented using a remote validation server to thereby obviate any need for changes or modifications to existing servers, or the invention can be implemented through changes at the server level, with changes or modifications being made to various servers. Thus, to authenticate e-mail messages, the invention can be implemented at the client level, e.g., in e-mail client software such as Microsoft® Outlook®, or at the server level as well as in between the server and the client, as would be desirable for e-mail portals such as Hotmail® and yahoo®.

Other objects, features, and advantages of the present invention will be readily appreciated upon a review of the subsequent description of the preferred embodiment and the appended claims, taken in conjunction with the accompanying drawings.

### BRIEF DESCRIPTION OF THE DRAWINGS

The accompanying Drawings incorporated in and forming a part of the specification illustrate several aspects of the invention and, together with the description, serve to explain the principles of the invention. In the Drawings:

FIG. 1 is a schematic showing the general system architecture employed by an exemplary implementation of the invention;

FIG. 2 shows the main steps of an exemplary method for receiving and validating a message using a unique message token or ID in accordance with the invention;

FIG. 3 shows the main steps of an exemplary method for generating and sending a message using unique message token or ID under the invention;

FIG. 4 shows the main steps of an exemplary method for generating the unique message identifier that is to be included in a message sent to one or more recipients; and

FIG. 5 is shows the main process steps for receiving and validating a message using a unique message token ID, in combination with unique tokens or ID's respectively associated with the sender and the recipient.

### DETAILED DESCRIPTION OF THE INVENTION

An exemplary system architecture and method for stopping unsolicited electronic messages, or “SPAM,” are provided. Throughout the following description,

“SendID” means a unique sender identifier (e.g., a token or ID) associated with a user and used in the context of sending a message;

“RecID” means a unique recipient identifier (e.g., a token or ID) associated with a user and used in the context of receiving a message;

“acID” means a unique message “anti-SPAM control ID” created for each message to be sent (not to be created or used again for any other message);

“SendPass” means a sender authentication mechanism, such as a password, used in the context of sending a message;

“RecPass” means a recipient authentication mechanism, such as a password, used in the context of receiving a message;

“SendersList” means a list of sender identifiers (SendID's) designated by a recipient, from whom the recipient has indicated a willingness to receive messages;

“vRecord” means a validation record associated with the message identifier (acID);

“vServer” means a server that creates message identifiers (acID's) and validation records (vRecord), and/or validates messages identifiers; and

“vindicator” means an indicator, returned by the vServer, representing vServer validation of a message identifier

Note that for any given user, the SendID and RecID may be the same actual user identifier granted by the system, in which case such a common user identifier correspond to either the SendID or the RecID in the following description, depending on the role this particular user plays in the context of a given message, i.e., the user being a sender or a recipient of the given message.

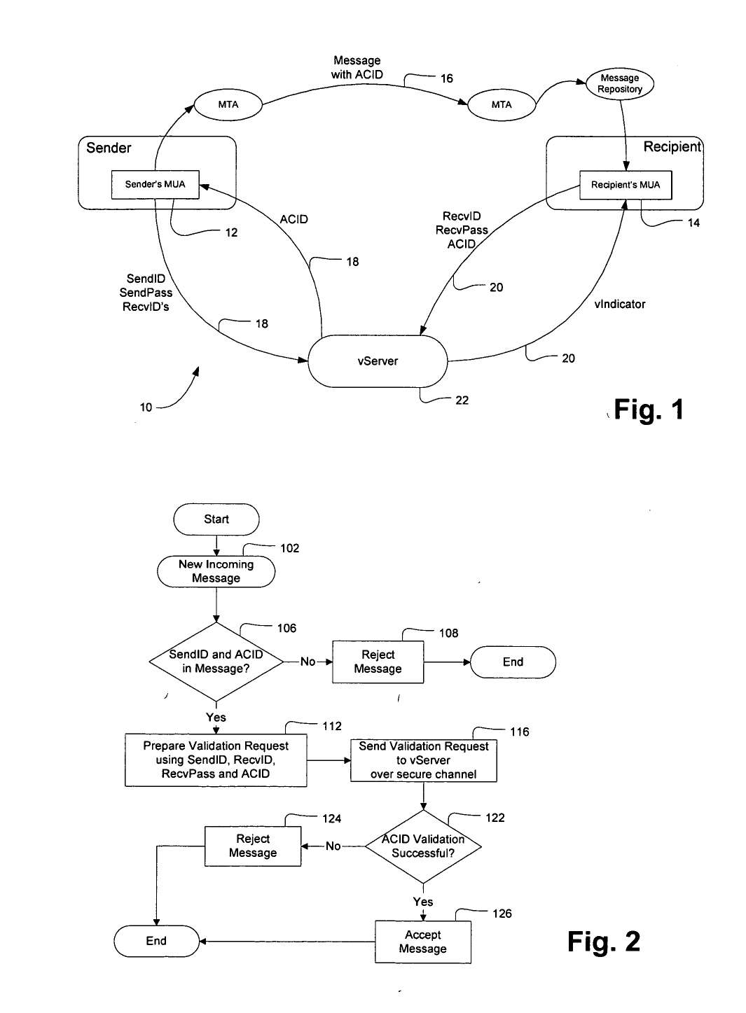

Referring to FIG. 1, by way of example only, a system architecture 10 for practicing the invention includes a sender having a messaging user agent (MUA) 12, and a recipient having a MUA 14 and accompanying message repository communicating with the sender's MUA 12 via a respective messaging transport agent (MTA) over a suitable communication link or channel 16. The system architecture 10 further includes a vServer 22 that respectively communicates with both the sender's MUA 12 and the recipient's MUA 14 via a HTTPS- or SSL-based tunnel, because a HTTPS- or SSL-based tunnel.

As illustrated in FIG. 1 and further described below in connection with FIGS. 2-5, the sender's MUA 12 first requests an acID from the vServer 22 by forwarding sender identification and authentication information, i.e., the SendID and SendPass, along with one or more RecID's. The vServer 22 authenticates the sender and thereafter determines whether the SendID is on the SendersList associated with each sender-provided RecID.

The vServer 22 then generates both an acID and a vRecord (1) if the SendID is on the SendersList, (2) if the SendID is associated with a group identifier on the SendersList, or is associated with a sub-group identifier that is itself associated with a group identifier on the SendersList, or, as described more fully below in connection with a scenario involving an exchange of business cards, (3) if the sender identifies himself using a default sender identifier that is on the SendList. The vRecord generated by the vServer 22 includes at least the acID, and the SendID and RecID associated with the acID. The vServer 22 then returns the acID to the sender's MUA 12, and either the sender or the sender's MUA inserts the acID in the “message,” i.e., into either the message header or the message body. The message is then sent by the sender's MUA 12 to the recipient's MUA 14.

Upon receipt of the message, the recipient or the recipient's MUA 14 retrieves the acID from the message and forwards the acID to the vServer 22 for validation, along with information with which the vServer 22 can authenticate the identity of the recipient, e.g., the RecID and the RecPass. After authenticating the recipient's identity, the vServer 22 validates the acID, “flags” the vRecord as having been used, and returns vIndicator to the recipient. The recipient or the recipient's MUA 14 then processes the message based on the vIndicator, for example, either by accepting the message and placing the message into the recipient's “InBox,” or by rejecting the message and routing the message to a “Junk Folder” for subsequent processing.

It is noted that, while the system architecture 10 as illustrated in FIG. 1 includes only a single vServer, it will be appreciated that, to provide scalability, the invention contemplates use of separate servers (not shown) to generate the acID and the vRecord, and to validate the acID and return the indication of message validity. Similarly, while the system architecture 10 employs the preferred secure channel between the vServer 22 and the respective MUA's 12,14, although less preferred, the invention contemplates use of nonsecure channels.

FIG. 2 is a logical flow diagram illustrating the steps executed by a recipient's MUA 14 in an exemplary method for authenticating an e-mail message. At step 102, a new message is received and is ready for validation processing. The message is inspected at step 106 for the presence of the SendID and the acID. If either or both the SendID and the acID are not located within the message, the message is rejected at step 108. This rejection may include the actual deletion of the message, or it may allow for its relocation to a “Rejected” or “Junk” folder for later processing or purging. If both the SendID and the acID are located within the message, a validation request is prepared at step 112 using the SendID, the acID, the RecID, and the RecPass. The RecPass is used by the recipient to verify their identity to the validation server, and can also be used by the recipient to access and modify recipient account information.

At step 116, the validation request is sent to the vServer 22 over a secure channel in order to protect the information being communicated including the RecPass. By way of example only, a preferred secure channel is a HTTPS- or SSL-based tunnel, because a HTTPS- or SSL-based tunnel allows requests to be sent from almost any location, even from behind firewalls and proxies. The vServer 22 receives the validation request, searches its system, and either validates or rejects the request at step 122, by confirming the existence of a vRecord associated with the acID, and returning a vIndicator. If the message is not valid, the message is “rejected” at step 124. If the request is validated, the message is “accepted” and may be delivered to the user at step 126.

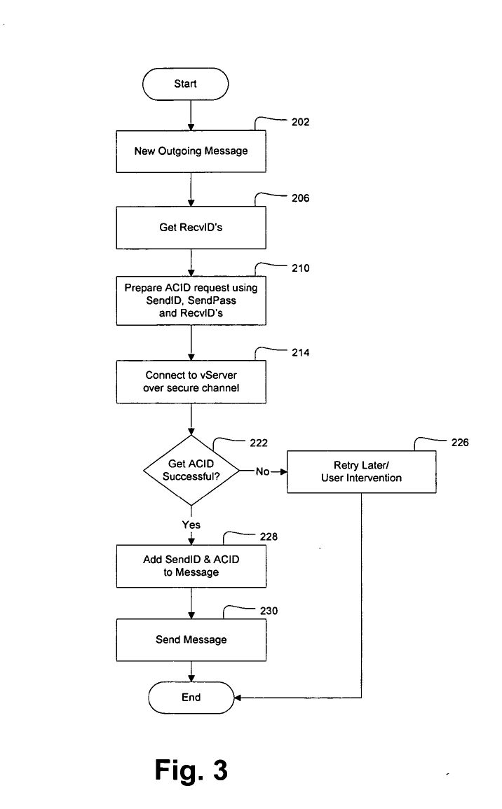

FIG. 3 presents a logical flow diagram illustrating the steps executed by a sender's MUA 12 in an exemplary method for authenticating an e-mail message. At step 202, a new message is being sent out. The sender's MUA 12 retrieves a list of RecID's, from the message at step 206. This list may consist of only one RecID in case of only one recipient, or may consist of a number of RecID's if more than one recipient is listed in the message. While the invention relies on unique identifiers issued to recipients and senders, the invention can advantageously utilize such existing sender and recipient identifiers as e-mail addresses, phone numbers, Instant Message ID's and others, as long as the vServer 22 can associate these ID's with its set of unique identifiers allocated for each user.

A request for generating a unique message acID is prepared at step 210 using the SendID, the SendPass, and the retrieved list of RecID's. The request is sent at step 214 to the vServer 22 over a secure channel. After authenticating the sender's identity, the vServer 22 will validate the request and either reject the request, or generate the acID and accept the request at step 222. If the request is rejected at step 226, the sender's MUA 12 may request intervention by the sender, or the sender's MUA 12 may try some other remedies and attempt the request at a later time. If the request is accepted, the SendID and the acID are added to the message at step 228, and the message is sent out at step 230.

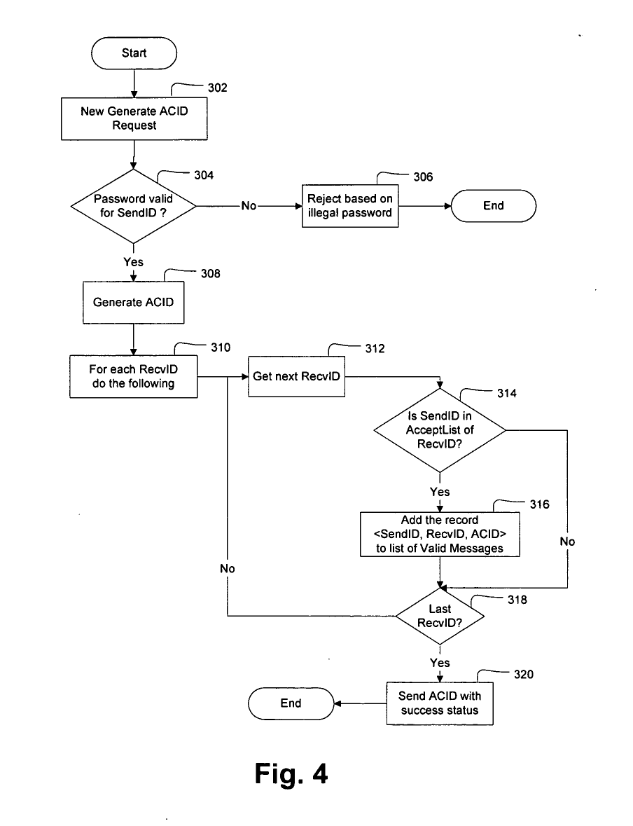

FIG. 4 illustrates the main steps used by a vServer 22 in an exemplary method to generate an acID and prepare for message validation. Step 302 shows the vServer 22 receiving a request to generate an acID. The vServer 22 authenticates the sender's use of the SendID in step 304 by verifying the SendPass sent in the request against the one stored for the SendID. If the passwords do not match, an error is returned at step 306 to indicate an incorrect password. If passwords match and, hence, the SendID is authenticated, the vServer 22 generates the acID at step 308 and prepares the stage for the validation request or requests that will come later from the one or more recipients of this message. In step 310, the system will go through the list of RecID's and, for each one, check in step 314 whether the recipient identified by RecID has added the sender identified by SendID to their SendersList.

If SendID is in the SendersList, at step 316, the vServer 22 adds a vRecord relating the SendID, RecID, and acID to the list of active validation records for later verification, and then move to step 318. If SendID is not in the SendersList of RecID, the vServer 22 checks if there are any more RecID's left in the request list at step 318. If there are additional RecID's in the list, then the vServer 22 loops back to step 312 to get the next RecID and repeat the process. If there are no more RecID's to process, the vServer 22 returns the acID to the sender at step 320, along with a success status for the request. It is noted that, where the acID request for a given message includes multiple RecID's, it is preferable to create a single acID for the message, although the invention also contemplates creating a different acID for each authenticated recipient. And, for a message sent to multiple authenticated recipients that employs a single acID, it will be appreciated that the vServer 22 creates as many vRecords as there are authenticated recipients, each vRecord being associated with the single acID and its respective recipient's RecID.

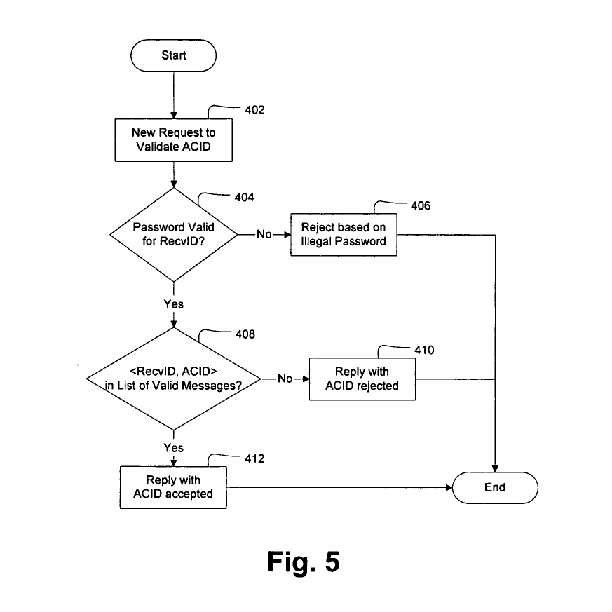

FIG. 5 illustrates the main steps used by a vServer 22 in an exemplary method to validate an acID. A request for validation is received by the vServer 22 at step 402. In step 404, the recipient's identity is authenticated by comparing the recipient's password, RecPass, to the stored value associated with the RecID. If there is no match, an error is returned that indicates an incorrect password at step 406. If the passwords match, the vServer 22 verifies the existence of a record relating to the SendID, RecID and acID at step 408. If such record does not exist, signifying an invalid message, a vIndicator is returned indicating an invalid message at step 410. Otherwise, the record exists and the message is valid. The vServer 22 then removes the record from its list of active records and return a success status for the validation request at step 412. Note that, while FIG. 5 shows the SendID as being part of the validation request, the SendID may be inferred and located by the vServer 22 using the acID. Hence, validation requests may be generated using only the RecID, and the authentication means for logging into the server, such as the RecPass, and the acID (as was the case in the above description of the system architecture 10 in FIG. 1).

Note that while the figures and corresponding descriptions refer to password authentication of users, embodiments of the present invention may use any other forms of authentication and user verification.

Note that the examples described above do not refer to any particular environment, such as e-mail or SMS. They are applicable to any and all of these environments. One of the requirements is that the ID's to be used are preferably unique. Hence, the Sender's ID (SendID) can be an e-mail Address which is unique in an e-mail environment, a phone number which is unique in the mobile and cellular phone environment, and so on. The system is likely, however to generate its own internal ID's for reference and more efficient processing.

A significant differentiating aspect of the invention over known anti-SPAM approaches is the use of unique ID's that can be created and authenticated only by the respective users. The acID and its corresponding validation record can only be created by the authentic sender of the message, as this sender is the only one that can authenticate with the server using the SendID and SendPass to create such acID's. The only method to create an acID is to login to a vServer 22 and authenticate using a SendID and, hence, the identity of the sender can be authenticated and guaranteed. In turn, the acID's can only be verified by the authenticated recipients, as they only can authenticate with the vServer using their RecID's to login and validate the acID's. And since the login processing is preferably taking place over secure channels, all transmitted information is protected and authenticity is guaranteed. This is a crucial property that this invention proposes and that current systems can not guarantee and no existing or proposed system so far offers within the context of messaging.

According to one embodiment of the invention, one of the main requirements for acID is to be unique to the message it represents and also very hard to predict ahead of time. One example of a potential method to create acID's is to make user of what is known as Universally Unique Identifiers (“UUID”). A UUID is a 128-bit number where implementations can guarantee more than 10 million unique and non-repeating UUID's per second per machine for millions of years to come. The nature of these numbers along with their shear quantity makes them statically impossible to predict. Another example is computing a message digest and using it as the acID. In addition to guaranteeing uniqueness, this approach has the advantage of also guaranteeing that the message itself is unaltered. Those skilled in the art can use either these or any other applicable method to create acID's as long as the uniqueness and predictability requirements are met properly.

According to another embodiment of the invention, the acID is both unique, as through use of a UUID, and based upon a message “fingerprint,” to thereby further ensure message authenticity, i.e., to ensure that a valid UUID-based acID was not intercepted and incorporated into an message not originating with the authenticated sender. In the context of the invention, the term “fingerprint” means a further identifier that is generated based on at least part of the message, and includes a “message digest.

As a further benefit, the system and method of the invention help to greatly diminish the possibility of transmitting and retransmitting worms, viruses and other kinds of undesirable message payloads by guaranteeing the identities of the senders as well as the messages. Under the invention, the only way to receive a message is if the recipient has already added the sender to their accepted senders list (SendersList). This, however, can only stop the spread of payloads coming from senders not included in the SendersList. In most circumstances, senders don't themselves elect to forward these payloads; the virus or worm itself will attempt to gather all known messaging addresses, i.e., e-mail addresses from an Address Book in Outlook or phone numbers from a Numbers Directory in a mobile phone, and forward-a message infected with the payload to these addresses.

In order to help maximize the ability to stop the spread and transmission of these undesirable message payloads, a preferred embodiment of this invention includes a requirement for a manual step during the sending process. This manual confirmation step is introduced anywhere before the actual transmission of the message, for example, before successful completion and insertion of the acID in the message to be sent, corresponding to step 228 or step 230 in the exemplary process illustrated in FIG. 3. This manual step can take the form of a confirmation step such as clicking a button or making a manual selection between different choices. The main idea is to prevent the worm or virus from automatically propagating itself to recipients. The virus will still be able to send itself out to a number of recipients; However, since the acID process requires a manual step, the virus will not be able to generate a message that can be authenticated by the recipient, and hence the message will not be received by any recipient with the ability to authenticate. Such embodiment is of great help to the current state of the industry where every month one hears about another worm or virus that wreaking havoc on millions of unsuspecting users.

According to one embodiment of the invention, a recipient registers for and subsequently receives a unique identifier (the RecID) along with authentication means, for example, a password. The RecID, along with the corresponding authentication means such as the RecPass, are used to access the recipient's account and perform future authentications and validations with the service. This assignment of a unique ID may be performed or needed for some or all of the messaging services. For example, a RecID may be assigned for an e-mail registration or an Instant Messaging registration, while the user's phone number may be accepted as a unique ID and used directly by the system.

A spammer that creates a SendID still has to have potential recipients add this SendID to their SendersList in order to accept the spammer's e-mails. Even if a spammer attempts to hijack the SendID of a legitimate Sender, the spammer would have no means of creating acID's and corresponding validation records, as that requires authentication with the vServer, i.e., the spammer would additionally need the authentication information held only by the legitimate sender. In addition, if a spammer attempts to hijack a SendID along with a legitimate acID by intercepting e-mail messages, they would still not be able to use that information because, once a message is verified with the vServer by a recipient, the validation record for the acID and that particular recipient can not be reused. Hence, any future messages using the same acID and Send[D will be rejected.

According to one embodiment of the invention, users are provided with a server where they can get information regarding potential senders and subsequently add them to their SendersList. In the case of e-mail, users may visit a web site offering the service, enter the e-mail address of a sender they would like to add to their SendersList, and subsequently add them to the list. Similar functionality may be offered for the users directly from the desktop without the explicit need for connecting and authenticating to a web site. A software program may be installed on the user's machine that automates this process for users and provides an easier process for additions, deletions and modifications to the SendersList. A particular implementation may or may not allow the addition of a sender who is not yet registered with the service, depending on the particular business model of the service.

According to one embodiment of the invention, senders can not register recipients for receiving e-mail. Recipients are in full control of what they want to receive and only they can decide to add or delete senders. In the case of e-mail services, this can seem to cause a problem for mailing lists that may have hundreds or even thousands of recipients, and under this scheme will not be able to directly register them. In one embodiment of the present invention, a mailing list wishing to send e-mails to recipients can register for the service, and obtain an ID to be used as a SendID. Subsequently, they may direct their potential recipients to a special URL that allows them to add this SendID to their SendersList. Alternatively, the mailing list may provide its SendID and allow the recipients to add it directly to their SendersList. As explained previously, users may also search themselves for the SendID of the mailing list to which they would like to subscribe and add it to their SendersList.

According to another embodiment of the present invention, the SendID can be either used directly or can be represented by a human friendly string or sentence. Hence, instead of a potentially incomprehensible string of seemingly random digits and/or characters, an English or UNICODE based sentence may be used to offer a more user-friendly interface. Recipients wanting to add Senders to their SendersList will not have to remember difficult SendID's, instead they will be able to use words that are familiar to them, possibly in their own languages and that are much easier to remember. On a related subject, entities that desire to send e-mail to users-have to get these potential recipients to add them to their SendersList. For example, legitimate advertisers and web site owners may want to register users for receiving a regular mailing. This can be accomplished by registering with the service and associating a friendly string, such as a product's slogan with the desired SendID. Recipients who use this string to add the SendID to their SendersList will be able to receive these mailings.

It is desirable to offer companies and corporations the ability for their users to receive internal e-mails without the need to add each employee individually. The same idea is applicable to any combination of individual and group relationships. According to one embodiment of the invention, this is accomplished by creating Super ID's that can represent groups, departments, division as well as companies and other entities. A service can be set up for a group where all members of the group have their ID's added to the list of the group's Super ID. Users can be added or deleted from the Super ID group based on various inclusion or exclusion rules, such as an employee leaving or a new one joining in. The message creation process may be modified to check for group membership. Hence, step 314 of FIG. 4 can check for group membership of the SendID as well as its inclusion in the SendersList. If the recipient has the sender in their SendersList or the recipient is a member of a corresponding Super ID group, step 316 of FIG. 4 will be executed and the validation record will be created. The actual validation process depicted in FIG. 5 can still function without modifications, since the validation record has already been created in the sending step. Users may include individual as well as group ID's in their accepted senders list. Since only authenticated senders with the corresponding ID's can create validation records, message authenticity is still guaranteed.

According to one embodiment of the invention, a recipient can provide authentication means to senders not included in the SendersList. An example from the context of e-mail would be, two persons meeting at an event and exchanging business cards. “Person A” would like to receive e-mails from people who receive his or her business card. The solution to this is to add the sender's ID to the SendersList. However, “Person A” wants to ensure they do not miss any e-mails that may be sent between meeting and adding the sender to the SendersList. Hence, “Person A” can provide a password that allows the other person to authenticate with the service using the SendID (or sender's e-mail in this case, if they do not have an ID), the RecID, and the password. The sender can then either register and get a SendID or just request a temporary SendID, generate an acID and the corresponding validation record, and to include the acID in the message. Such service is also fully under the control of the recipient who can modify the authentication means at their own convenience. Once a sender is registered and added to the SendersList by the recipient, they no longer need to go through these steps.

As an alternative to, or in addition to, the above use of a default identifier in such “business card exchange” and other similar scenarios, a recipient is able to choose to accept “invitations” from authenticated senders which, when processed by an authenticated recipient in a way that preferably requires manual entry to ensure authenticity of recipient identity, provides a convenient mechanism for adding otherwise unknown-but-authenticated senders to the authenticated recipient's SendersList. Because only authenticated senders can send such “invitations,” i.e., and because the invitations are preferably accepted or rejected by an authenticated recipient only after the recipient logs into the vServer 22, the use of such “invitations” is both inherently resistant to spamming and, further, nonintrusive to invitation recipients.

While the above description constitutes the preferred embodiment, it will be appreciated that the invention is susceptible to modification, variation and change without departing from the proper scope and fair meaning of the subjoined claims.

For example, while the invention is described above in the context of authenticating an e-mail message, it will be appreciated that the invention is suitable for authenticating a wide variety of electronic “messages,” including without limitation instant messages, and mobile sms, as well as any and all end-to-end messaging systems.

We claim:

1. A method for authenticating an electronic message comprising:
generating, for a sender identified on a list of senders, a unique message identifier for transmission in the message; and
generating a validation record associated with the message identifier and a recipient identifier associated with a recipient; and
validating the message identifier forwarded by the recipient with the validation record.

2. The method of claim 1, further including authenticating the identity of the sender prior to generating the message identifier.

3. The method of claim 1, wherein the sender list includes a group identifier, and the sender is identified as being associated with the group identifier.

4. The method of claim 1, wherein the sender list includes a default identifier associated with the identity of the recipient, and wherein the sender is identified with the default identifier by matching a password to a second reference string.

5. The method of claim 1, further including authenticating the identity of the recipient prior to validating.

6. The method of claim 1, wherein generating the message identifier is based at least in part on a message fingerprint.

7. The method of claim 1, further including the step of including the message identifier in the message prior to transmitting the message from the sender to the recipient.

8. The method of claim 7, further including retrieving the message identifier from the message prior to validating.

9. The method of claim 1, further including the step of processing the message based on validating.

10. The method of claim 1, wherein validating includes confirming the existence of the validation record.

11. The method of claim 10, further including computer-executable instructions for flagging the validation record after confirming.

12. A computer-readable medium having computer-executable instructions for performing steps comprising:
receiving, from a sender of an electronic message, a request for a message identifier, wherein the request includes a recipient identifier associated with an identified recipient of the message;
generating, only when the sender is identified on a list of senders, a unique message identifier and a validation record, the validation record being associated with the message identifier and the recipient identifier; and
forwarding the message identifier to the sender.

13. The method of claim 12, wherein the sender list includes a group identifier, and the sender is identified as being associated with the group identifier.

14. The method of claim 12, wherein the sender list includes a default identifier associated with the identity of the recipient, and wherein the sender is identified with the default identifier by matching a password to a second reference string.

15. The method of claim 12, further including authenticating the identity of the sender prior to generating the message identifier and the validation record.

16. The method of claim 12, wherein generating the message identifier is based at least in part on a message fingerprint.

17. A computer-readable medium having computer-executable instructions for performing steps comprising:
receiving, from a recipient of an electronic message, a request including a message identifier and a recipient identifier associated with the recipient;
validating the message identifier with a validation record associated with the message identifier and the recipient identifier; and
forwarding an indication to the recipient based on validating.

18. The computer-readable medium of claim 17, further including computer-executable code for authenticating the identity of the recipient prior to validating.

19. The computer-readable medium of claim 18, wherein authenticating the identity of the recipient includes matching a password to a reference string associated with the recipient identifier.

20. The computer-readable medium of claim 17, wherein validating includes confirming the existence of the validation record.

21. The computer-readable medium of claim 20, further including computer-executable instructions for flagging the validation record after confirming.

22. A computer-readable medium having computer-executable instructions for performing steps comprising:
requesting, from a server prior to transmission of an electronic message, a unique message identifier associated with a validation record;
receiving the message identifier from the server; and
transmitting the message identifier in the message.

23. The computer-readable medium of claim 22, wherein the server generates the message identifier based on one or more of the group consisting of an authenticated sender identity, a recipient identity, and a list of senders associated with the recipient identity.

24. The computer-readable medium of claim 22, further including computer-executable instructions for obtaining information for authenticating the sender.

25. The computer-readable medium of claim 24, wherein requesting includes transmitting the information to the server.

26. The computer-readable medium of claim 22, further including computer-executable instructions for generating a message fingerprint.

27. The computer-readable medium of claim 26, wherein requesting includes transmitting the message fingerprint to the server.

28. A computer-readable medium having computer-executable instructions for performing steps comprising:
retrieving an message identifier transmitted in an electronic message;
requesting, from a server, a validation of the message identifier based on a validation record associated with the message identifier and a recipient identifier associated with the recipient;
receiving an indication of message validation from the server; and
processing the electronic message based on the indication.

29. The computer-readable medium of claim 28, further including computer-executable instructions for obtaining information for authenticating the identity of the recipient.

30. The computer-readable medium of claim 29, wherein requesting includes transmitting the information to the server.

31. The computer-readable medium of claim 28, wherein processing includes rejecting the message if the message is not valid.

32. A computer-readable storage medium having stored thereon a data structure comprising:
a first data field containing a recipient identifier associated with an authenticated recipient;
a second data field containing a sender identifier associated with an authenticated sender of electronic messages,
a third data field containing a unique message identifier for a given message sent by the authenticated sender to the authenticated recipient, the third data field being related to the first data field and the second data field.

33. The computer-readable storage medium of claim 32, wherein said data structure further includes a fourth data field associated with the third data field, wherein the fourth data field contains an indication of whether the third data field has been matched.

34. The computer-readable storage medium of claim 32, wherein said data structure further includes a fifth data field associated with the first data field, with which to authenticate the identity of the recipient.

35. The computer-readable storage medium of claim 32, wherein the message identifier for the given message is based at least in part on a fingerprint of the given message.

36. The computer-readable storage medium of claim 32, wherein said data structure further includes a sixth data field relating the first data field to the second data field, whereby the authenticated recipient agrees to receive electronic messages from the authenticated sender.

37. The computer-readable storage medium of claim 36, wherein said data structure further includes a seventh data field associated with the second data field, with which to authenticate the sender.
